(19) United States
(12) Patent Application Publication
(10) Pub. No.: US 2010/0029196 A1
(43) Pub. Date: Feb. 4, 2010

(54) SELECTIVE WIRELESS COMMUNICATION

(75) Inventor: Min-Liang TAN, Singapore (SG)

Correspondence Address: CONLEY ROSE, P.C.;David A. Rose, P. O. BOX 3267, HOUSTON, TX, 77253-3267, US

(73) Assignee: JOOK, INC., Carlsbad, CA (US)

(21) Appl. No.: 11/969,405

(22) Filed: Jan. 4, 2008

Related U.S. Application Data
(63) Continuation-in-part of application No. 11/625,692, filed on Jan. 22, 2007.

(51) Int. Cl. H04H 20/71

(52) U.S. Cl. 455/3.01

(57) ABSTRACT

A communication management method enabling selective wireless communications. The method comprises providing a reference profile data and detecting presence of a device by transmission of at least a portion of a primary profile data by the device. The primary profile data comprises an identifier, a pseudo name, contact details and/or preferences and bio-data of the device's user. The method also involves determining distance of the device from a reference location and initiating communication with the device in response to the device being within a reference distance from the reference location and/or at least a portion of the primary profile data matching at least a portion of the reference profile data.

### RELATED APPLICATION

This application is a continuation-in-part of U.S. Ser. No. 11/625,692 filed Jan. 22, 2007, and claims the benefit thereof.

### FIELD OF INVENTION

The present invention relates generally to the field of wireless communications. More specifically, the present invention relates to selective wireless communication among devices.

### BACKGROUND OF INVENTION

Many prior art media devices can receive radio broadcasts from sources including FM, AM or satellite broadcasts. Signals can be transmitted from one source to another via physical means or, increasingly, wirelessly. Typically, signals that are convertible into data, audio sounds, visuals or text are transmitted between devices via a cable or a wire. Transmission of signals via cables or wires restricts the distance of signal transmission as well as increases cost of communication.

The rapid pace of development in communications technology has seen wireless communication become an integral part of our lives. A wireless connection, detection or communication involves the linkage of two or more devices without the use of physical wires. Typically, wireless connection, detection or communication utilizes spread-spectrum or orthogonal frequency division multiplexing (OFDM) modulation technology based on radio waves to enable communication between devices within a defined area. Wireless communication technology gives users mobility to move around freely within the defined area while still being able to communicate with other wireless devices within the same defined area.

Such wireless connection, detection and communication ability is increasingly incorporated into a wide variety of different devices including computers, laptops, personal digital assistants (PDAs), handphones or cellphones and media devices (for example, audio devices, video devices as well as audiovisual devices). Wireless communications has become increasingly popular in the home due to increasing ease of installation. Public businesses such as coffee shops, fast food restaurants and shopping malls are also beginning to offer wireless access enabling wireless connection, detection and communication; and at some locations, even as a free service. Additionally, several major cities around the world have or are starting to build large wireless network projects.

Typically, wireless devices within the same defined area are able detect and communicate with each other indiscriminately. The user of a first wireless device often has little opportunity, if at all, to specifically select or restrict the detection and communication with a second wireless device. The indiscriminate detection and communication between wireless devices often results in a host of inconveniences and disadvantages including undesired or time-wasting communication with other users, loss of privacy and reduced information security.

In view of the foregoing, there is a need for a system and method for enabling a wireless device (and its user) to selectively define conditions or criteria for, and thus control, the detection and communication with other wireless devices.

### SUMMARY

In accordance with a first aspect of the invention, there is disclosed a communication management method comprising providing a reference profile data, detecting presence of a device by detecting transmission of at least a portion of a primary profile data sent by the device, and determining distance of the device from a reference location. The method further comprises initiating communication with the device in response to at least one of the device being within a reference distance from the reference location and at least a portion of the primary profile data matching at least a portion of the reference profile data.

In accordance with a second aspect of the invention, there is disclosed a communication management system comprising means for providing a reference profile data, means for detecting presence of a device by detecting transmission of at least a portion of a primary profile data sent by the device, and means for determining distance of the device from a reference location. The system further comprises means for initiating communication with the device in response to at least one of the device being within a reference distance from the reference location and at least a portion of the primary profile data matching at least a portion of the reference profile data.

In accordance with a third aspect of the invention, there is disclosed a device-readable medium having stored therein a plurality of programming instructions, which when executed, the instructions cause the device to provide a reference profile data, detect presence of a device by detecting transmission of at least a portion of a primary profile data sent by the device, determine distance of the device from a reference location, and initiate communication with the device in response to at least one of the device being within a reference distance from the reference location and at least a portion of the primary profile data matching at least a portion of the reference profile data.

### BRIEF DESCRIPTION OF DRAWINGS

Embodiments of the invention are described hereinafter with reference to the following drawings, in which:

FIG. 1 illustrates a schematic view of wireless communication of signals in accordance with one aspect of the present invention;

FIG. 2 illustrates a schematic view of wireless communication of signals from a single source to multiple destinations in accordance with another aspect of the present invention;

FIG. 3 and FIG. 4 illustrate other embodiments of the invention in which a plurality of rebroadcasts of signals occur;

FIG. 5 illustrates a schematic view of wireless communications of signals between multiple devices in accordance with another aspect of the present invention; and

FIG. 6 shows a wireless communication method implementable by one of the devices of FIG. 5.

### DETAILED DESCRIPTION

With reference to the drawings, preferred embodiments of the present invention for providing a system and a method for selective detection and communication between devices are described hereinafter.

Systems and methods for wireless detected and communication between devices are known in the art. Typically, detection occurs when two devices are brought together within a pre-determined range or distance. However, devices currently on the market are unable to specifically set criteria or conditions for authorizing detection and communication between devices. This therefore results in indiscriminate detection and communication between devices, which is often undesirable, inconvenient or disadvantageous for a user of the device. The system and method for selective detection and communication between devices as provided by the present invention therefore allows the user of the device to selectively detect, allow detection thereof and/or communicate with a second device.

For purposes of brevity and clarity, description of the invention is limited hereinafter to devices capable of selectively detecting, allowing detection thereof and communicating with other devices. This however does not preclude various embodiments of the invention from other applications that require a similar operating performance. Functional and operational principles upon which embodiments of the invention are based on remain the same throughout the various embodiments.

The device is preferably a standalone device which can include audio playback, telecommunication or personal digital assistant (PDA) functionalities. Alternatively, the device is a dongle couplable to an audio device, a telecommunication device, a PDA or a similar device.

### Dedicated and Broadcast Use

As shown in FIG. 1, the user of a first device 10 can opt to only transmit a dedicated signal from the first device to a second device 20; in this instance, the second device 20 will be the only receiving device for the first device 10. The second device 20 decodes the signal from the first device 10 to provide the user of the second device 20 with the appropriate/desired information. As set forth below in further detail, in a preferred embodiment, the information transmitted by the second device 20 as well as the information received by the first device 10 can be specifically selected or chosen by individual respective users of the first device 10 and the second device 20.

As used herein, the term “dedicated” is used to refer to a closed network, whereby only users of that network may have ready access to the decoding and/or decrypting technology to access the communicated signals. A “closed” network can refer to a network that employs proprietary technology that is not directly interoperable with other standards-based networks, or that adds an additional layer of encoding onto standards-based networks. A “closed network” also encompasses a private network that can only be used by authenticated or authorized devices; e.g. outsider use may be prohibited and enforced through cryptographic means. A closed network is thus distinct from an open network such as Bluetooth, whereby any device that is Bluetooth-enabled may (in the absence of proprietary encoding or encryption) receive and process that signal.

Information stored in the device may also be encrypted to provide a further layer of security to information communication between devices. Encryption can be used to secure information communications and stored information. Digital communications accommodate the use of encryption. As consumers continue to move from wireline to wireless communications devices, the use of encryption has become more important to the end user in some contexts.

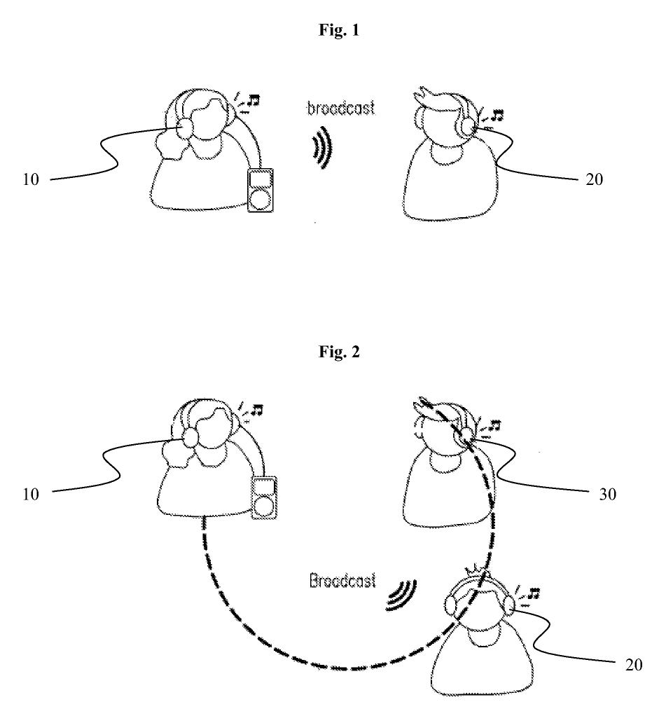

Referring now to FIG. 2, the user of the first device 10 can opt to set the first device 10 to broadcast. As such, enabled third parties in the range of transmission of the first device 10, such as the user of a third device 30 and potentially others, can opt to set their respective devices to detect and receive signals from the first device 10, or on a channel on which the first device 10 is set to transmit. The third device 30 can now decode the signal transmitted from the first device 10 to provide the user of the third device 30 with the appropriate/desired information.

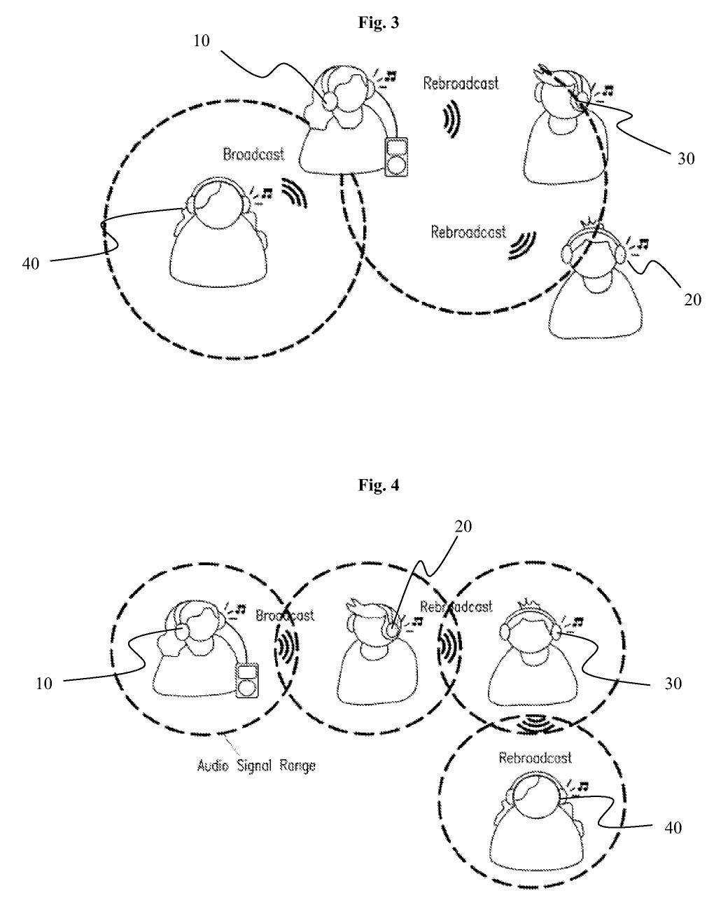

As shown in FIG. 3, the user of the first device 10 can also opt to set the first device 10 to receive from other transmitting devices, including the second device 20 and the third device 30.

### Rebroadcasting

The system and method of the present invention can also be used in the context of rebroadcasting. For example, as shown in FIG. 4, the user can set the first device 10 on broadcast, the user of the second device 20 which is receiving the signals can opt to set the second device 20 to receive the signals from the first device 10 and to simultaneously re-broadcast the same signals to other users' devices (for example, the third device 30 and a fourth device 40). Alternatively, the second device 20 can simultaneously receive signals from the first device 10 as well as transmit information, in a form of data signals, already stored within the second device 20 to other users' devices (for example, the third device 30 and the fourth device 40).

Rebroadcasting may be undertaken before, after and during decoding of original signals. If the signals have been decoded prior to rebroadcasting, the signals will be encoded again prior to retransmission. Preferably, the encoding produces the same original signal. Alternatively, the encoding produces a modified signal.

Rebroadcasting thus allows the user of the third device 30 who is out of the range of the first device 10 but in the range of the re-broadcast of the second device 20 to receive the appropriate signals from the first device 10 via the second device 20. Likewise, if the user of the third device 30 opts to set the third device 30 to re-broadcast, the user of the fourth device 40, who is out of the range of the broadcast of the first device 10 and the rebroadcast of the second device 20, can opt to set the fourth device 40 to receive the appropriate signals from the first device 10 via the second device 20 and the third device 30. For each broadcasting option as described above, the users of the second device 20, the third device 30 and the fourth device 40 can also set their respective devices to receive signals which are being broadcasted and rebroadcasted.

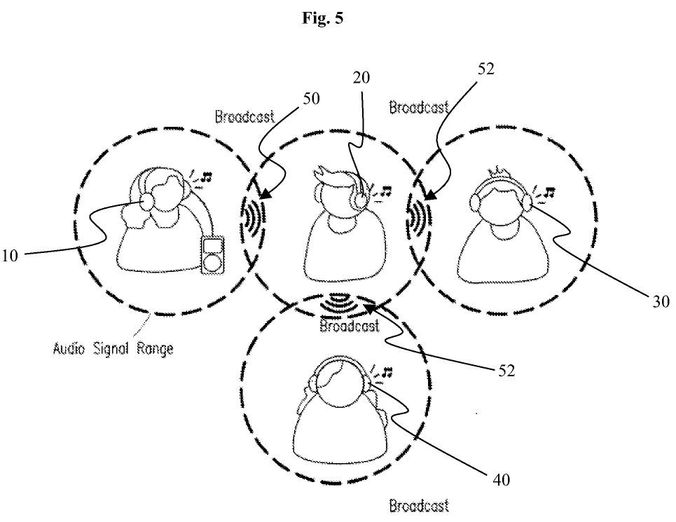

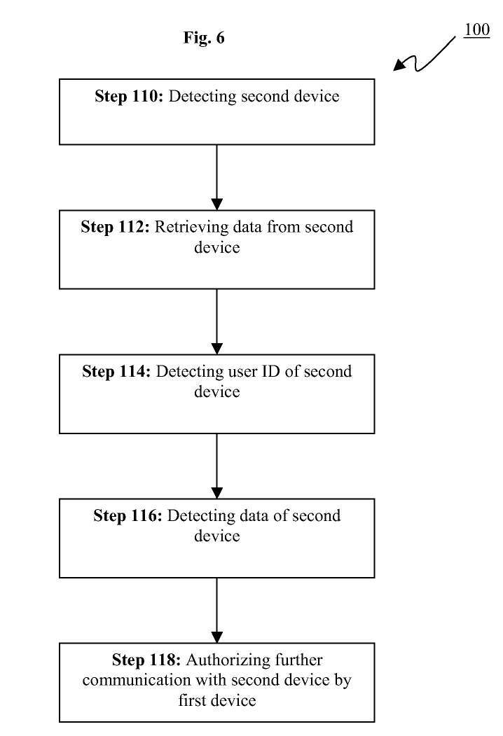

FIG. 5 depicts an alternative embodiment of the invention that enables use with the simultaneous reception and transmission/broadcast of different audio sounds. As shown in FIG. 5, the user of the first device 10 can set the first device 10 to transmit or broadcast a certain signal 50. The user of the second device 20 can set his device to receive the transmission/broadcast of the signal 50 from the first device 10. The user of the second device 20 can simultaneously opt to set the second device 20 to transmit or broadcast a different signal 52 on a different channel which can be received by users of, for example, the third device 30 and the fourth device 40 provided that they have set their respective devices to receive the transmission or broadcast of the signal 52 on that channel from the user of the second device 20.

The setting of the first device 10 to transmit or to simultaneously transmit and receive can be selected manually by the user of the first device. Alternatively, the setting of the first device 10 to receive, to transmit or to simultaneously transmit and receive is performed automatically upon detection of signals from another device, such as the second device 20 or the third device 30.

Preferably, the device also enables use in multi-channel transmission or broadcast (simultaneous or otherwise). With multiple users transmitting in a limited range, the implementation of the wireless transmission may be made un-dedicated channels which users may opt to receive either:

i. automatically via hunting and/or frequency hopping; or

ii. manually by tuning to specific frequencies denoted by:

a. discrete channels denoted by numbers (e.g. Channel 1, Channel 2, etc);

b. discrete channels denoted with colors (e.g. Red, Green, Blue); or

c. other methods consistent with those known to persons of skill in the art.

In order to identify the mode in which the device is operating (transmitting, broadcasting, re-broadcasting or receiving), the user of the device can opt to set either cues on his device or cues to be displayed/received on third parties' device to allow third parties to identify the mode in which the device is operating. The cues could take various forms or combination of forms such as:
a. visual cues, including text, colored indicators or lights, which will indicate the various modes in which the device is operating; and
b. sound cues which will indicate the various modes in which the device is operating. Such sounds can either be heard audibly or through use of the device.
   (For example, the first device 10 is set to broadcast. The first device 10 flashes a blue light which users of other Devices (e.g. the second device 20 and the third device 30) can see and then opt to set the second device 20 and the third device 30 to receive the first device's broadcast.)

### Restriction of Communication Based on Range

In a preferred embodiment of the invention, the first device 10 is able to restrict communication with the second device 20 based on distance. A user of the first device 10 can opt to program the first device 10 to communicate with other devices, such as the second device 20, within a pre-determined or pre-selected distance (hereinafter referred to as a “detecting range”). Preferably the first device 10 is also programmed to communicate with the second device 20 when the first device 10 comes within a pre-determined distance from the second device 20 (hereinafter referred to as a “detectable range”). More preferably, the detecting range and the detectable range are each independently adjustable. For the first device 10 to communicate with the second device 20, the second device 20 must preferably have a detectable range within the detecting range of the first device 10.

Provided the second device 20 is within the detecting range of the first device, the first device 10 is still able to communicate with a third device 30 that is out of the detecting range of the first device 10 but still within the detecting range of the second device 20. Preferably, the user of the first device 10 is able to select both the detecting range of the first device 10 as well as the detecting range of the second device 20, thereby allowing the user of the first device 10 to control the ability full or total detecting range of the first device 10.

The detecting range of the first device 10 is optionally dependant on a signal strength of the second device 20. Alternatively, the detecting range of the first device is dependant on a signal strength of the third device 30. Further alternatively, the detecting range of the first device 10 is dependent on the signal strength of the second device 20 and the signal strength of the third device 30.

By selecting the detecting range, the user of the first device 10 is able to selectively restrict his communication with other devices based on a distance criterion.

### Restriction of Communication Based on Stored Information Fields

The user of the first device 10 can opt to restrict ability of the first device 10 to communicate with the second device 20 based on content of data stored within information fields of the second device 20.

Devices, such as the second device 20, are able to store data. Data can be classified within different information fields, including, but not limited to:

a. User profile

b. User unique identifier (ID) or pseudonym

c. User online profile

d. Device unique identifier (ID)

Preferably, the user of the second device 20 stores data within each and every information field. Alternatively, the user of the second device 20 only stores data within selected information fields.

A single information field typically consists of a number of data fields. For example, the information field of “user profile” can contain data fields including, but not limited to:

a. Name of user

b. Age of user

c. Gender of user

d. Hobbies of user

e. Address of user

f. Food preferences of user

g. Preferred friends of user

h. Likes of user

i. Dislikes of user

The user of the second device 20 can opt to allow the user of the first device 10 to have access to all of the stored data within the second device 20. Alternatively, the user of the second device 20 can restrict or limit access to the stored data within the second device 20.

Preferably, the first device 10 is able to receive data stored within the second device 20 and thereafter analyze the received data to one of authorize or reject further communication with the second device 20. Further preferably, authorization or rejection of further communication with the second device 20 is determined by both the detecting range of the first device and received data by the first device 10.

The user of the first device 10 can opt to construct an inclusive list of user IDs. The first device 10 is therefore authorized or enabled to communicate with a device with a user ID found within the inclusive list. Alternatively, the user of the first device 10 can opt to construct an exclusive list of user IDs. The first device 10 is barred or disenabled to communicate with a device having a user ID found within the exclusive list.

Communication between the first device 10 and the second device 20 is performed by a communication method 100 implemented by the first device 10 as shown in FIG. 6. In a step 110 of the communication method 110, the first device 10 detects the presence of the second device 20. The first device 10 preferably detects the second device 20 because the second device 20 is of the same device type or model. Alternatively, the first device 10 detects the presence of all devices, including the second device 20, within the detecting range of the first device 10. Further alternatively, the first device 10 detects all devices found on a same network or an approved network.

In a step 112, the first device 10 retrieves data from the second device 20. The data retrieved includes, but is not limited to, data from the previously mentioned information fields. In a step 114, the first device 10 detects the user ID of the second device 20. If the user ID of the second device 20 is found within the inclusive list of the first device 10, the first device 10 authorizes further communication with the second device 20. Alternatively, if the user ID of the second device is found within the exclusive list of the first device 10, the first device 10 then bars further communication with the second device 20.

In a step 116, the first device 10 detects the data stored within a number of pre-selected data fields of the second device 20. The first device 10 then authorizes or rejects further communication or data exchange in a step 118. Preferably, the first device 10 authorizes or rejects further communication and/or data exchange with the second device 20 based on detected user ID of second device together with the detected data. Alternatively, the first device 10 authorizes or rejects further communication and/or data exchange with the second device 20 solely based on detected user ID of the second device. Further alternatively, the first device 10 authorizes or rejects further communication and/or data exchange based solely on detected data.

The quantity, type and/or content of requisite matching data (otherwise known as criteria) for the authorization of further communication between the first device 10 with the second device 20 is determined or selected by the user of the first device 10. In other words, the user of the first device 10 is able to dictate the number of and the content of data fields of the second device 20 that must first match before authorizing the further communication with the second device 20.

As previously mentioned, the user of the second device 20 is able to restrict access to selected data fields by the user of the first device 10. This restriction is typically done to protect the second user's privacy and relative anonymity.

Therefore, the user of the first device 10 can preferably opt to enable a start of an initial (or initiation) phase of further communication with the second device 20 based on a partial match of selected requisite data. During the initial phase, the user of the first device 10 can opt to request for additional data from the second device 20. Preferably, the request is programmed to be carried out automatically by the first device 10. Further preferably, authorization or rejection of further communication or data exchange occurs upon detection and matching of selected requisite data.

The second device 20 can be coupled to the Internet. The second device 20 is able to download or retrieve data from the Internet. For example, the second device 20 is able to download an online user profile such as a Facebook® or Flicker® profile. The first device 10 is able to retrieve the online user profile of the second device. The retrieval of the online user profile of the second device by the first device 10 preferably occurs simultaneously with the retrieval of the user ID of the second device 20. Alternatively, the retrieval of the online user profile of the second device 20 by the first device 10 occurs independently without the retrieval of the user ID of the second device 20.

A device in a more preferred embodiment of the present invention incorporates functionalities of both the first device 10 and the second device 20. More preferably the device incorporating the functionalities of both the first device 10 and the second device 20 performs these functionalities concurrently or simultaneously.

### Location-Based Communication

The first device 10 is detectable by a network base station or device. Preferably, the base station is located at a fixed location. The base station has a pre-determined detection range. Preferably, the detection range of the base station is manipulatable or adjustable by an operator or user.

Preferably, the first device 10 is detectable by the base station upon entering the detection range of the base station. Upon detection of first device 10, the base station communicates with the first device 10. The base station is able to transmit data or information to the first device 10. The data or information is preferably location specific. The data fields of data or information includes, but is not limited to:

a. Advertisements

b. Weather forecasts

c. Selected shops and shopping promotions

d. Neighboring restaurants

e. Traffic and road conditions

Preferably, the user of the first device 10 can choose to receive or not to receive the data provided by the base station. Further preferably, the user of the first device 10 is able to set conditions or parameters for data transmitted from the base station. For example, the user of the first device 10 can opt to receive data from only the data field of traffic and road conditions or only from the data field of neighboring restaurants.

The first device 10 can opt to transmit received data from the base station to the second device 20 that is out of the detection range of the base station but within that of the first device 10. The detecting range of the second device 20 is optionally dependent on a signal strength of the first device 10.

In the foregoing manner, embodiments of a device capable of selective detection and communication with other devices are described. Although the present invention has been described with reference to particular embodiments, it will be apparent to one skilled in the art in view of this disclosure that numerous changes and/or modifications can be made without departing from the scope and spirit of the invention.

1. A communication management method comprising:
providing a reference profile data;
detecting presence of a device by detecting transmission of at least a portion of a primary profile data sent by the device;
determining distance of the device from a reference location; and
initiating communication with the device in response to at least one of the device being within a reference distance from the reference location and at least a portion of the primary profile data matching at least a portion of the reference profile data.

2. The method as in claim 1, the primary profile data comprising at least one of an identifier, a pseudo name, contact details, preferences and bio-data of a user

3. The method as in claim 1, determining distance of the device from a reference location comprising:
identifying a portion of a plurality of base stations, the portion of the plurality of base stations in signal communication with the device, each of the plurality of base stations having a predefined location, the plurality of base stations for forming a communication network;
deriving an estimated location of the device from the portion of the plurality of base stations; and
determining the distance of the device from the reference location by comparing the estimated location of the device with the reference location.

4. The method as in claim 1, further comprising:
comparing at least one primary data element with at least one reference data element, the reference profile data comprising the at least one reference data element and the primary profile data comprising the at least one primary data element.

5. The method as in claim 4, initiating communication with the device comprising:
initiating communication with the device in response to at least one of the device being within the reference distance from the reference location and the at least one primary data element matching the at least one reference data element.

6. The method as in claim 1, further comprising:
comparing a primary identifier with a plurality of reference identifiers, the primary profile data comprising the primary identifier and the reference profile data comprising the plurality of reference identifiers.

7. The method as in claim 6, initiating communication with the device comprising:
initiating communication with the device in response to at least one of the device being within the reference distance from the reference location and the primary identifier matching one of the plurality of reference identifiers.

8. The method as in claim 6, initiating communication with the device comprising:
impeding communication with the device in response to at least one of the device being within the reference distance from the reference location and the primary identifier matching one of the plurality of reference identifiers.

9. The method as in claim 1, initiating communication with the device comprising:
sending a request for secondary profile data from the device.

10. The method as in claim 1, initiating communication with the device comprising:
sending at least one of user profile data and media data to the device, the media data being at least one of audio data, video data and textual data, and the media data being pre-recorded.

11. A communication management system comprising:
means for providing a reference profile data;
means for detecting presence of a device by detecting transmission of at least a portion of a primary profile data sent by the device;
means for determining distance of the device from a reference location; and
means for initiating communication with the device in response to at least one of the device being within a reference distance from the reference location and at least a portion of the primary profile data matching at least a portion of the reference profile data.

12. The system as in claim 11, the primary profile data comprising at least one of an identifier, a pseudo name, contact details, preferences and bio-data of a user

13. The system as in claim 11, means for determining distance of the device from a reference location comprising:
means for identifying a portion of a plurality of base stations, the portion of the plurality of base stations in signal communication with the device, each of the plurality of base stations having a predefined location, the plurality of base stations for forming a communication network;
means for deriving an estimated location of the device from the portion of the plurality of base stations; and
means for determining the distance of the device from the reference location by comparing the estimated location of the device with the reference location.

14. The system as in claim 11, further comprising:
means for comparing at least one primary data element with at least one reference data element, the reference profile data comprising the at least one reference data element and the primary profile data comprising the at least one primary data element.

15. The system as in claim 14, means for initiating communication with the device comprising:
means for initiating communication with the device in response to at least one of the device being within the reference distance from the reference location and the at least one primary data element matching the at least one reference data element.

16. The system as in claim 11, further comprising:
means for comparing a primary identifier with a plurality of reference identifiers, the primary profile data comprising the primary identifier and the reference profile data comprising the plurality of reference identifiers.

17. The system as in claim 16, means for initiating communication with the device comprising:
means for initiating communication with the device in response to at least one of the device being within the reference distance from the reference location and the primary identifier matching one of the plurality of reference identifiers.

18. The system as in claim 16, means for initiating communication with the device comprising:
means for impeding communication with the device in response to at least one of the device being within the reference distance from the reference location and the primary identifier matching one of the plurality of reference identifiers.

19. The system as in claim 11, means for initiating communication with the device comprising:
means for sending a request for secondary profile data from the device.

20. The system as in claim 11, means for initiating communication with the device comprising:
means for sending at least one of user profile data and media data to the device, the media data being at least one of audio data, video data and textual data, and the media data being pre-recorded.

21. A device-readable medium having stored therein a plurality of programming instructions, which when executed, the instructions cause the device to:
provide a reference profile data;
detect presence of a device by detecting transmission of at least a portion of a primary profile data sent by the device;
determine distance of the device from a reference location; and
initiate communication with the device in response to at least one of the device being within a reference distance from the reference location and at least a portion of the primary profile data matching at least a portion of the reference profile data.

22. The device-readable medium as in claim 21, the primary profile data comprising at least one of an identifier, a pseudo name, contact details, preferences and bio-data of a user

23. The device-readable medium as in claim 21, the plurality of programming instructions, which when executed, cause the device further to:
identify a portion of a plurality of base stations, the portion of the plurality of base stations in signal communication with the device, each of the plurality of base stations having a predefined location, the plurality of base stations for forming a communication network;
derive an estimated location of the device from the portion of the plurality of base stations; and
determine the distance of the device from the reference location by comparing the estimated location of the device with the reference location.

24. The device-readable medium as in claim 21, the plurality of programming instructions, which when executed, cause the device further to:
compare at least one primary data element with at least one reference data element, the reference profile data comprising the at least one reference data element and the primary profile data comprising the at least one primary data element.

25. The device-readable medium as in claim 24, the plurality of programming instructions, which when executed, cause the device further to:
initiate communication with the device in response to at least one of the device being within the reference distance from the reference location and the at least one primary data element matching the at least one reference data element.

26. The device-readable medium as in claim 21, the plurality of programming instructions, which when executed, cause the device further to:
comparing a primary identifier with a plurality of reference identifiers, the primary profile data comprising the primary identifier and the reference profile data comprising the plurality of reference identifiers.

27. The device-readable medium as in claim 26, the plurality of programming instructions, which when executed, cause the device further to:
initiate communication with the device in response to at least one of the device being within the reference distance from the reference location and the primary identifier matching one of the plurality of reference identifiers.

28. The device-readable medium as in claim 26, the plurality of programming instructions, which when executed, cause the device further to:
impede communication with the device in response to at least one of the device being within the reference distance from the reference location and the primary identifier matching one of the plurality of reference identifiers.

29. The device-readable medium as in claim 21, the plurality of programming instructions, which when executed, cause the device further to:
send a request for secondary profile data from the device.

30. The device-readable medium as in claim 21, the plurality of programming instructions, which when executed, cause the device further to:
send at least one of user profile data and media data to the device, the media data being at least one of audio data, video data and textual data, and the media data being pre-recorded.
